(19) United States
(12) Patent Application Publication
(10) Pub. No.: US 2008/0282866 A1
(43) Pub. Date: Nov. 20, 2008

(54) SHEET PUNCH DEVICES FOR VARIOUS PATTERNS

(75) Inventor: Hyung-Dae BAE, Seoul (KR)

Correspondence Address: STEIN, MCEWEN & BUI, LLP, 1400 EYE STREET, NW, SUITE 300, WASHINGTON, DC, 20005, US

(73) Assignee: DN CRAFT CORPORATION, Seoul (KR)

(21) Appl. No.: 12/116,447

(22) Filed: May 7, 2008

(30) Foreign Application Priority Data
May 17, 2007 (KR) 2007-48064

(51) Int. Cl. B26F 1/14

(52) U.S. Cl. 83/687

(57) ABSTRACT

A sheet punch device comprises a lower base providing a reference plane on which a sheet material is placed, the lower base having a jig formed with a pattern hole for punching a sheet material; a punching unit aligned onto the lower base, the punching unit including a punching block having a cutting blade sliding up and down to pass through the pattern hole of the jig to thereby punch the sheet material; and an intermediate plate separated from the punching unit and detachably attached onto the lower base with the sheet material interposed between the intermediate plate and the lower base.

### CROSS-REFERENCE TO RELATED APPLICATION

This application claims the benefit of Korean Application No. 2007-48064, filed May 17, 2007, in the Korean Intellectual Property Office, the disclosure of which is incorporated herein by reference.

### BACKGROUND OF THE INVENTION

1. Field of the Invention

The present invention relates to a punch device for punching a sheet material such as paper, letters and cards, more particularly to a sheet punch device which enables a user to see a punching position of the sheet material to thereby punch various kinds of patterns.

2. Description of the Related Art

In general, a punch device has a jig formed with a pattern hole and a punching block having a sharp cutting blade passing through the pattern hole, and punches the same pattern as the pattern hole on a sheet such as paper.

Korean Patent No. 0591639 discloses one of such punches entitled with ‘rotary punch devices’. The punch device comprises an upper plate having a punching block formed with a cutting blade, and a lower plate including a lower jig. Also, the punching block is provided on an upper rotary plate rotatably installed on the upper plate, and the lower plate is provided on a lower rotary plate rotatably installed on the lower plate.

The upper and lower plates have a plurality of magnets on the opposite surfaces, and the upper and lower rotary plates also have a plurality of magnets on the opposite surfaces. First, a user supplies a sheet to be punched on the lower plate, and then places the upper plate on the lower plate for aligning the upper and lower plates by means of an attraction of the magnets to thereby punch the sheet. After that, the upper and lower plates are rotated to be punched with the sheet interposed between the upper and the lower plates and then punched repeatedly.

However, since the sheet material is interposed between the upper and lower plates in the conventional punch device, a punched area is limited.

The relation of position between a previous pattern and a subsequent pattern is determined by the predetermined designed structure, i.e., a rotational structure of the upper and lower rotary plates, but not selected by a user.

Also, in order to move the sheet material for punching another area, a user has to remove the upper plate, then move the sheet material, and place the upper plate again on the sheet material by means of an attraction force of the magnets with holding the sheet material by a hand.

However, it is very difficult to hold the sheet material on the right position, and the previous pattern and the subsequent pattern are determined by the substantial structure of the punch device as the same as the above

### SUMMARY OF THE INVENTION

The present invention is designed to solve the above problems of the prior art. It is an object of the invention to provide a sheet punch device by which various kinds of patterns may be punched according to user's desire not the structure of the punch device.

Another object of the invention is to provide a sheet punch device which enables a user to see a pattern to be punched on the sheet material during the punching operation.

Still another object of the invention is to provide a sheet punch device in which the sheet material can be moved for punching another area with the sheet material attached.

In order to accomplish the above object, the present invention provides a

sheet punch device comprising: a lower base providing a reference plane on which a sheet material is placed, the lower base having a jig formed with a pattern hole for punching a sheet material; a punching unit aligned onto the lower base, the punching unit including a punching block having a cutting blade sliding up and down to pass through the pattern hole of the jig to thereby punch the sheet material; and an intermediate plate separated from the punching unit and detachably attached onto the lower base with the sheet material interposed between the intermediate plate and the lower base.

Preferably, the intermediate plate is made of a transparent material.

Also, the sheet punch device comprises a plurality of first magnets provided on the lower base; and a plurality of second magnets provided on the intermediate plate for connection with the first magnets by a magnetic attraction force.

More preferably, the intermediate plate has a through hole corresponding to the pattern hole of the jig.

The invention may further comprise a means for aligning the cutting blade of the punching block with the pattern hole of the jig.

Preferably, the lower base comprises a base plate providing a reference plane on which the sheet material is placed, the base plate having a recess in which the jig rests to move laterally to a short distance.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view showing a sheet punch device according to a preferred embodiment of the present invention;

FIG. 2 is a perspective view showing an assembled state of a sheet punch device according to a preferred embodiment of the present invention;

FIG. 3 is an exploded perspective view showing a sheet punch device according to a preferred embodiment of the present invention;

FIG. 4 is a side view schematically showing an assembled state of an intermediate plate and a lower jig of a sheet punch device according to the preferred embodiment of the present invention;

FIGS. 5 and 6 are plan views schematically showing a punching operation using a sheet punch device according to the preferred embodiment of the present invention; and

FIGS. 7 to 9 are views showing various patterns obtained from a sheet punch device according to the preferred embodiment of the present invention.

### DETAILED DESCRIPTION OF THE EMBODIMENTS

Hereinafter, preferred embodiments of the present invention will be described in detail with reference to the accompanying drawings. However, it should be understood that the terms in the description and the appended claims should not be construed as limited to general and dictionary meanings, but interpreted based on the meanings and concepts corresponding to technical aspects of the present invention on the basis of the principal that the inventor is allowed to define terms appropriately as a lexicographer.

Therefore, the embodiments herein are just preferable examples for the purpose of illustrating the invention, not intended to limit the scope of the invention, so it should be under stood that other equivalents and modifications could be made thereto without departing from the spirit and scope of the invention.

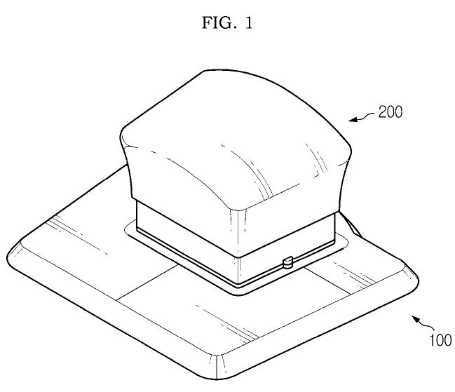

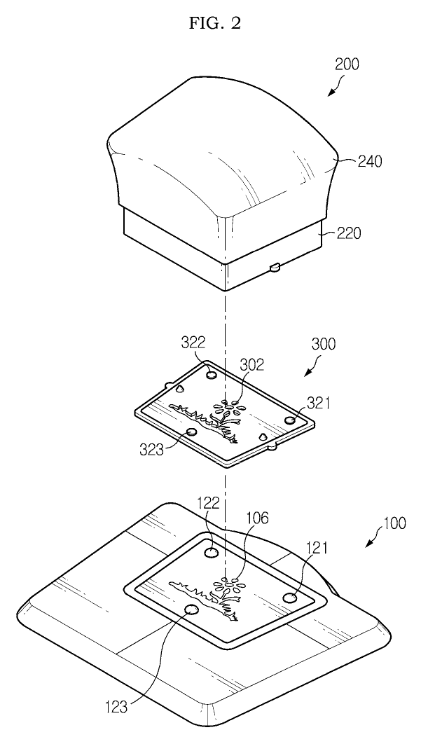

FIGS. 1 and 2 show a sheet punch device according to a preferred embodiment of the present invention. The punch device punches a predetermined pattern in paper, letters or cards (hereinafter referred as ‘a sheet material’).

Referring to the drawings, the sheet punch device of the present invention comprises a lower base 100 providing a reference plane on which a sheet material is placed, a punching unit 200 detachably attached to the upper surface of the lower base 100 and including a punching mechanism for punching the sheet material inside, and a intermediate plate 300 interposed between the lower base 100 and the punching unit 200.

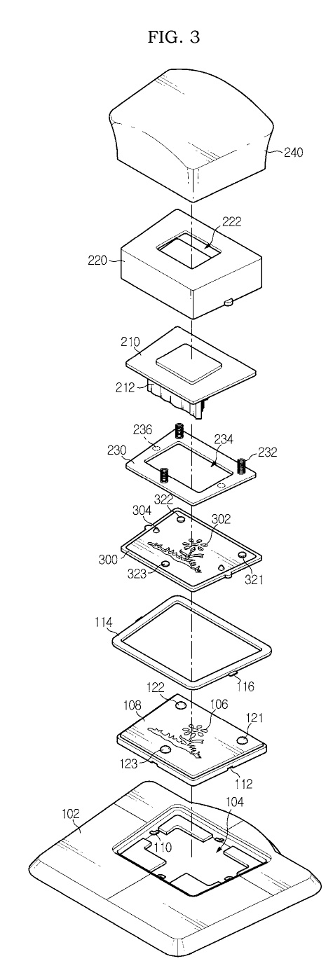

The invention will be shown in detail in FIG. 3. The lower base 100 comprises a base plate 102 providing a flat reference plan on which the sheet material is placed.

A recess 104 is formed on the upper surface of the base plate 102, and a jig 108 having a pattern hole 106 of a predetermined shape formed in the vertical direction rests on the recess 104. Preferably, a plurality of coupling protrusions 110 are formed on the inner side of the recess 104 to connect with connection grooves 112 on the side of the jig 108.

Also, a bracket 114 to press on the edge of the jig 108 is further provided to prevent the jig 108 from escaping from the recess 104. A protrusion 116 on the side of the bracket 114 connects with a groove (not shown) on the side of the recess 104.

More preferably, the recess 104 is slightly larger than the jig 108 so that the jig 108 move laterally to a short distance, which facilitate the alignment of the cutting blade and the pattern hole 106 when punching the sheet material.

The punching unit 200 comprises a punching block 210 sliding up and down through the pattern hole 106 of the jig 108 to punch the sheet material. The punching block 210 has a cutting blade 212 having a shape corresponding to the pattern hole 106 on the lower surface of the punching block 210 to passing through the pattern hole 106 for punching the sheet material.

The punching block 210 is contained in the housing 220 to be supported upward by an elastic force. In doing so, a support 230 is installed on the lower portion of the punching block 210 while a plurality of elastic members 232 such as a spring are interposed between the punching block 210 and the support 230 to elastically bias the punching block 210 upward.

Since the support 230 connects with the housing 220, the punching block 210 can be maintained in the housing 220 not to pop out.

Also, the support 230 has a guide hole 234 in the form of the same pattern as the pattern hole 106. The cutting blade 212 of the punching block 210 slides up and down while being inserted in the guide hole 234.

The housing 220 also has an opening 222 on the top so that the upper portion of the punching block 210 is exposed out of the housing 220 through the opening 222.

A press member 240 is provided on the housing 220 and a press protrusion (not shown) pressing the upper surface of the punching block 210 is formed on the lower surface of the press member 240.

The sheet punch device of the present invention comprises an intermediate plate 300 which is separate from the punching unit 200 and detachably installed on the lower base 100 for maintaining the position of the sheet material.

The intermediate plate 300 is formed with a through hole 302 corresponding to the pattern hole 106 of the jig 108, through which the cutting blade 212 passes. It should be understood that the through hole 302 is for guiding the movement of the cutting blade 212 of the punching block 210 sliding up and down through the through hole 302 not for punching the sheet material. Accordingly, the through hole 302 does not have to have the same shape as that of the pattern hole 106, but may have any shapes by which the cutting blade 212 can be guided to pass.

In addition, the intermediate plate 300 acts to prevent the sheet material from being taken upward by the cutting blade 212 when the cutting blade 212 slides up to return after punching. Thus, the through hole 302 may be appropriately shaped as long as such an operation can be implemented.

Preferably, the intermediate plate 300 is made of a transparent material such as polycarbonate or glass so that a user can see the sheet material under the intermediate plate 300.

With such a configuration, a user can check the punched pattern upon each punching so that the punched pattern may be designed according to the user's desire.

Alternatively, the intermediate plate 300 may be made of an opaque material.

According to the present invention, the intermediate plate 300 is attached to the lower base 100 by means of a magnetic attachment means comprising a plurality of first magnets 121, 122 and 123 provided on the lower base 100, and a plurality of second magnets 321, 322 and 323 corresponding to the first magnets 121, 122 and 123, which is provided on the intermediate plate 300.

Alternatively, the first magnets 121, 122 and 123 may be provided on the upper surface of the base plate 102.

The first magnets 121, 122 and 123 and the second magnets 321, 322 and 323 are attached to each other by an attraction force thereof.

Now the operation of the present invention having the above configuration will be described below.

FIG. 5 illustrates a sheet material ST to be punched on the lower base 100 where only the jig 108 and the pattern hole 106 are shown with other elements omitted for convenience.

First, the sheet material ST is placed on the lower base 100 so that an area to be punched with pattern is positioned on the jig 108.

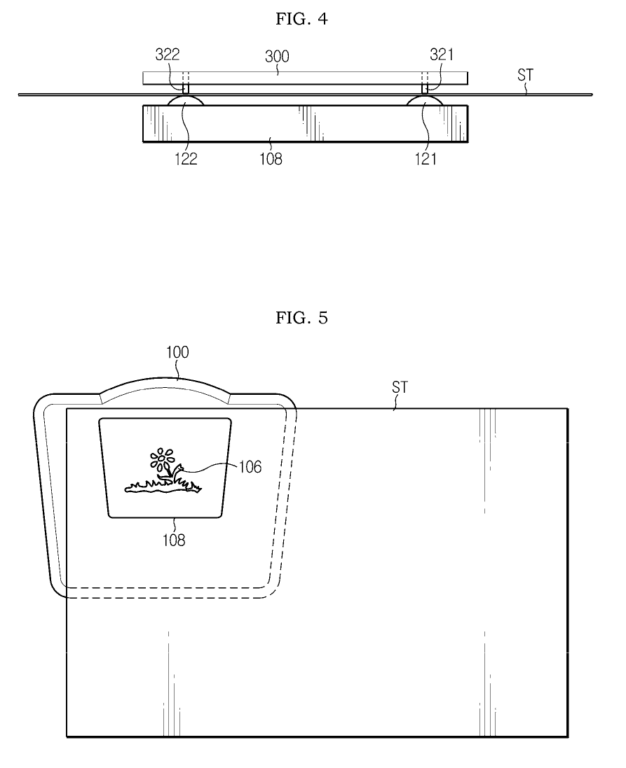

Then, the intermediate plate 300 is attached onto the lower base 100 with the sheet material ST interposed between them as shown in FIG. 4. At this time, the first magnets 121, 122 and 123 provided on the lower base 100 and the second magnets 321, 322 and 323 provided on the intermediate plate 300 are attached to each other by a magnetic attraction force.

Preferably, the contact points between the first magnets 121, 122 and 123 and the second magnets 321, 322 and 323 are shaped in order to minimize the contact area thereof. Also, the contact points of the magnets are rounded to minimize the friction between the sheet material ST and the magnets when moving the sheet material ST. Accordingly, FIG. 4 shows an example of the first magnets having the upper surface rounded and the second magnets 321, 322 and 323 having a minimum contact area.

With the sheet material ST positioned, the punching unit 200 is placed on the lower base 100 by means of an alignment means. The alignment means aligns the cutting blade 212 of the punching block 210 in the punching unit 200 with the pattern hole 106 of the jig 108.

According to the preferred embodiment, a plurality of alignment protrusions 304 are formed on the upper surface of the intermediate plate 304, and a plurality of alignment grooves 236 (see FIG. 3) corresponding to the alignment protrusions 304 are formed the lower surface of the support 230, so that the position of the punching unit 200 is determined to the lower base 100 by connection of the alignment protrusions 304 and the alignment grooves 236.

It should be understood that the configuration of the alignment means is not limited to the embodiment, and may have, for example, alignment protrusions formed on the upper surface of the base plate 102 while alignment grooves are formed on the lower surface of the larger support.

After the alignment of the punching unit 200, the press member 240 is pressed for punching the sheet material ST. When the press member 240 is pressed, a press protrusion (not shown) presses the punching block 210 downward. Accordingly, the cutting blade 212 passes through the through hole 302 of the intermediate plate 300 to be inserted into the pattern hole 106 of the jig 108 to thereby punch the sheet material ST.

Although the cutting blade 212 is misaligned with the pattern hole 106 of the jig 108 to some extend, the jig 108 is capable of slightly moving laterally in the recess 104 when the cutting blade 212 passes through the pattern hole 106, which facilitates the alignment as set forth above.

Although not shown in the drawings, various kinds of means for aligning the cutting blade and the pattern hole may be adopted.

Subsequently, the pressing force against the press member 240 is removed, and then the punching block 210 returns to the original position by the elastic members 232 between the support 230 and the punching block 210. At this time, the intermediate plate 300 prevents the sheet material ST from being taken upward.

A user removes the punching unit 200 form the lower base 100 for the next punching. Nevertheless, the sheet material ST still remains fixed with interposed between the intermediate plate 300 and the jig 108.

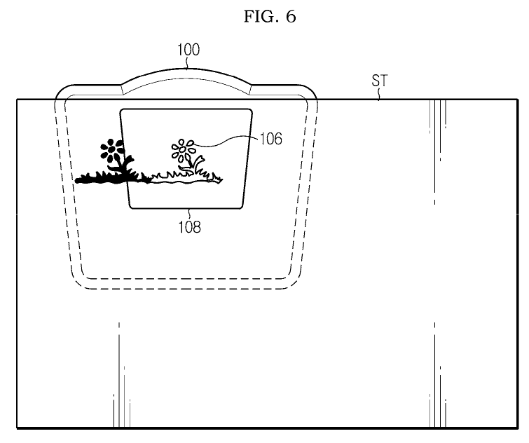

After that, the user moves the sheet material ST in the direction as he likes for the next punching as shown in FIG. 6. At this time, since the friction occurs only at the contact points of the first magnets 121, 122 and 123 and the second magnets 321, 322 and 323, the sheet material ST can be moved with very little force.

Also, the sheet material ST continues to be clamped by the first magnets 121, 122 and 123 and the second magnets 321, 322 and 323 after being moved. The blackened pattern in FIG. 6 denotes a previously punched portion.

In case that the intermediate plate 300 is made of a transparent material according to the preferred embodiment of the invention, the user can see the sheet material ST and the punched patterns during punching and moving the sheet material ST through the intermediate plate 300.

Then, the punching unit 200 is placed on the lower base 100 to thereby punch the next pattern in the sheet material ST as set forth above.

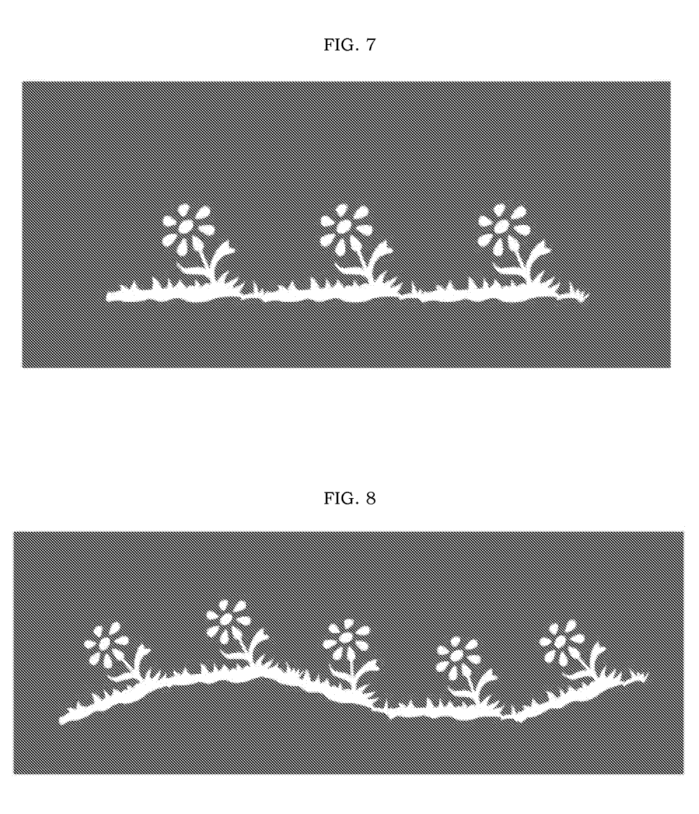

The user repeats the above steps to obtain a resultant sheet in the form of desired pattern. For example, in case that the sheet material ST is repeatedly punched while being moved linearly as shown in FIG. 6, a linear pattern of FIG. 7 is obtained.

In another example, the sheet material ST is moved in the horizontal and vertical directions at the same time during punching, which results in the pattern as shown in FIG. 8.

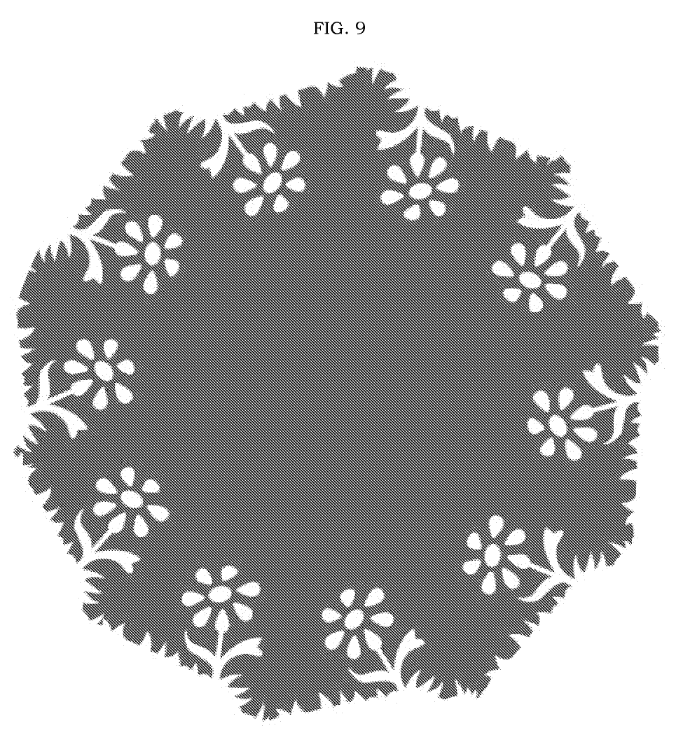

FIG. 9 shows the pattern results from the operation of punching as the sheet material ST is rotated.

According to the present invention, the sheet material is punched a pattern not by predetermined structure of the punch device but by user's desire.

The present invention adopts the transparent intermediate plate which enables a user to see the sheet material and the punched pattern during punching. Also, the sheet material is moved with clamped, which facilitates a stable punching.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A sheet punch device comprising:
a lower base providing a reference plane on which a sheet material is placed, the lower base having a jig formed with a pattern hole for punching a sheet material;
a punching unit aligned onto the lower base, the punching unit including a punching block having a cutting blade sliding up and down to pass through the pattern hole of the jig to thereby punch the sheet material; and
an intermediate plate separated from the punching unit and detachably attached onto the lower base with the sheet material interposed between the intermediate plate and the lower base.

2. The sheet punch device according to claim 1, wherein the intermediate plate is made of a transparent material.

3. The sheet punch device according to claim 1, further comprising:
a plurality of first magnets provided on the lower base; and
a plurality of second magnets provided on the intermediate plate for connection with the first magnets by a magnetic attraction force.

4. The sheet punch device according to claim 1, wherein the intermediate plate has a through hole corresponding to the pattern hole of the jig.

5. The sheet punch device according to claim 1, further comprising a means for aligning the cutting blade of the punching block with the pattern hole of the jig.

6. The sheet punch device according to claim 1, wherein the lower base comprises a base plate providing a reference plane on which the sheet material is placed, the base plate having a recess in which the jig rests to move laterally to a short distance.
